(19) United States
(12) Patent Application Publication
(10) Pub. No.: US 2014/0293894 A1
(43) Pub. Date: Oct. 2, 2014

(54) DISTRIBUTING DYNAMICALLY FREQUENCY-SHIFTED INTERMEDIATE FREQUENCY (IF) RADIO FREQUENCY (RF) COMMUNICATIONS SIGNALS IN DISTRIBUTED ANTENNA SYSTEMS (DASS), AND RELATED COMPONENTS, SYSTEMS, AND METHODS

(71) Applicant: Coming Optical Communications Wireless, Ltd., Airport City (IL)

(72) Inventors: Ofer Saban, Vienna, VA (US); Isaac Shapira, Petach Tikva (IL); Dror Ben-Shiomo, Modin (IL)

(73) Assignee: Coming Optical Communications Wireless, Ltd., Airport City (IL)

(21) Appl. No.: 14/223,078

(22) Filed: Mar. 24, 2014

Related U.S. Application Data
(60) Provisional application No. 61/806,134, filed on Mar. 28, 2013.

(51) Int. Cl. H04W 72/12

(52) U.S. Cl. CPC H04W 72/1289
USPC 370/329

(57) ABSTRACT

Distributed antenna systems (DASs) distributing dynamically frequency-shifted intermediate frequency (IF) radio frequency (RF) communications signals are disclosed. In embodiments disclosed herein, a dynamic bandwidth control unit (DBCU) is configured to provide a plurality of IF RF communications signals for distribution over a communications medium to one or more remote units (RUs) in a DAS. The DBCU is configured to instruct a frequency conversion controller to shift a frequency of each of a plurality of RF communications signals to non-overlapping intermediate frequencies. For at least one of the plurality of RF communications signals, the shifted, intermediate frequency is dynamically selected by the DBCU based on the frequency of at least one other RF communications signals. In this manner, the frequencies of the RF communications signals may be shifted to dynamically selected IFs in order to optimize available bandwidth of the communications medium in the DAS.

### PRIORITY APPLICATION

This application claims the benefit of priority under 35 U.S.C. §119 of U.S. Provisional Application No. 61/806,134, filed on Mar. 28, 2013, the content of which is relied upon and incorporated herein by reference in its entirety.

### BACKGROUND

The technology of the disclosure relates generally to distributing communications signals, and more particularly to distributing dynamically frequency-shifted intermediate frequency (IF) radio frequency (RF) communications signals, which may be used in distributed antenna systems (DASs).

No admission is made that any reference cited herein constitutes prior art. Applicant expressly reserves the right to challenge the accuracy and pertinence of any cited documents.

Wireless communications are rapidly growing, with ever-increasing demands for high-speed mobile data communications. As an example, local area wireless services (e.g., “wireless fidelity” or “WiFi” systems) and wide area wireless services are frequently deployed in many different areas (e.g., coffee shops, airports, libraries, etc.). Distributed communications or antenna systems communicate with wireless devices called “clients,” or “client devices”, which must reside within a wireless range or “cell coverage area” in order to communicate with an access point. Distributed antenna systems (DASs) are particularly useful when deployed in indoor environments where client devices may not otherwise be able to effectively receive radio frequency (RF) signals from a source such as a base station. Applications where DASs can be used to provide or enhance coverage for wireless services include public safety, cellular telephony, wireless local access networks (LANs), location tracking, and medical telemetry inside buildings and over campuses.

One approach to deploying a DAS involves the use of RF antenna coverage areas, also referred to as “antenna coverage areas.” Antenna coverage areas are formed by remotely distributed antenna units, also referred to as remote units (RUs). The RUs are configured to couple to one or more antennas configured to support the desired frequency(ies) or polarization to provide the antenna coverage areas. Antenna coverage areas can have a radius in a range from a few meters up to twenty meters. Combining a number of RUs creates an array of antenna coverage areas. Because the antenna coverage areas each cover small areas, there are typically only a few users (clients) per antenna coverage area. This arrangement generates a uniform high quality signal enabling high throughput supporting the required capacity for users of the wireless system.

As the wireless industry evolves, DASs are becoming more sophisticated. DASs may require more complex electronic circuits to enable better use of limited bandwidths and to provide additional functionality. For example, electronic circuits may be employed for additional functionalities, such as interference reduction, increased output power, handling high dynamic range, and signal noise reduction. Further, the functionality of the RUs may be included in an (access point) AP in a distributed wireless communications system. It may be desired to provide the RUs' functionality in APs in a distributed wireless communications system without changing or enlarging the form factor of the APs.

### SUMMARY

In embodiments disclosed herein, a dynamic bandwidth control unit (DBCU) provides a plurality of intermediate frequency (IF) RF communications signals for distribution over a communications medium to one or more remote units (RUs) in a DAS. The DBCU is configured to instruct a frequency conversion controller to shift a frequency of each of a plurality of RF communications signals to non-overlapping intermediate frequencies (IFs). For at least one of the RF communications signals, the shifted IF is dynamically selected by the DBCU based on the frequency of at least one other RF communications signals. In this manner, the frequencies of the RF communications signals may be shifted to dynamically selected intermediate frequencies in order to optimize available bandwidth of communications media in the DAS. For example, by optimizing bandwidth usage in the available bandwidth, unused bandwidth between adjacent IF signals can be minimized, thereby increasing a total number of RF communications signals that can be transmitted over lower-bandwidth media, and maximizing the amount of remaining available bandwidth of the communications medium.

One embodiment relates to a DBCU for controlling frequency conversion of RF communications signals in a DAS. The DBCU is configured to identify a plurality of RF communications signals. The DBCU is further configured to sequentially assign an IF for each of the plurality of RF communications signals, wherein assigning at least one IF is based on a previously assigned IF. The DBCU is further configured to determine a plurality of mixing frequencies for converting the plurality of respective RF communications signals into the plurality of respective IF signals.

An additional embodiment relates to a method for controlling frequency conversion of RF communications signals in a DAS. The method comprises identifying a plurality of RF communications signals, sequentially assigning an IF for each of the plurality of RF communications signals, wherein assigning at least one IF is based on a previously assigned IF, and determining a plurality of mixing frequencies for converting the plurality of respective RF communications signals into the plurality of respective IF signals.

An additional embodiment relates to a DAS having a DBCU for controlling frequency conversion of RF communications signals. The DBCU is configured to identify a plurality of downlink RF communications signals, and to sequentially assign a downlink IF for each of the plurality of downlink RF communications signals, wherein assigning at least one downlink IF is based on a previously assigned downlink IF. The DBCU is further configured to determine a plurality of mixing frequencies for converting the plurality of respective downlink RF communications signals into the plurality of respective downlink IF signals, and to generate a management signal containing information regarding the downlink RF communications signals and the downlink IF signals. The DAS further includes a head-end unit (HEU) associated with the DBCU configured to transmit the plurality of downlink Ifs, and at least one RU. Each RU is configured to receive the plurality of downlink IFs and convert the plurality of downlink IFs to the plurality of downlink RF communications signals.

An additional embodiment relates to a non-transitory computer-readable medium comprising instructions for directing a processor to perform a method for controlling frequency conversion of RF communications signals in a DAS. The method comprises identifying a plurality of RF communications signals, and sequentially assigning an IF for each of the plurality of RF communications signals, wherein assigning at least one IF is based on a previously assigned IF. The method further comprises determining a plurality of mixing frequencies for converting the plurality of RF communications signals into a plurality of IF signals.

Additional features and advantages are set forth in the detailed description, and in part will be readily apparent to those skilled in the art from the description or recognized by practicing the embodiments as described in the written description. The foregoing general description and the following detailed description are merely exemplary, and are intended to provide an overview to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE FIGURES

FIG. 1 is schematic diagram view of a conventional distributed antenna system (DAS) capable of distributing wireless communications signals to client devices;

FIG. 2 is a schematic diagram view of a multiple radio band distributed RF communications system employing a dynamic bandwidth control unit (DBCU) for providing dynamically shifted RF communications services to remote units (RUs);

FIG. 3 is a schematic diagram view of a channel identifier for the DBCU of FIG. 2 for providing dynamically shifted RF communications services to RUs of one embodiment;

FIG. 4A is a graphical representation of bandwidth usage by a conventional multiple radio band distributed RF communications system for providing conventionally shifted RF communications services to RUs of one embodiment;

FIG. 4B is a graphical representation of bandwidth usage by a multiple radio band distributed RF communications system employing a DBCU for providing dynamically shifted RF communications services to RUs of one embodiment;

FIG. 5 is a flowchart diagram view of a method of operating a DBCU of one embodiment;

FIG. 6 is a schematic diagram view of a DAS that includes the distributed RF communications system in FIG. 2 and a distributed wireless local access network (WLAN) system for providing digital data services to WLAN access points (APs), wherein the distributed WLAN and RF communications systems share a distribution communications media; and

FIG. 7 is a schematic diagram of a generalized representation of a computer system that can be included in or interface with any of the DBCUs described herein, wherein the computer system is adapted to execute instructions from computer-readable media.

### DETAILED DESCRIPTION

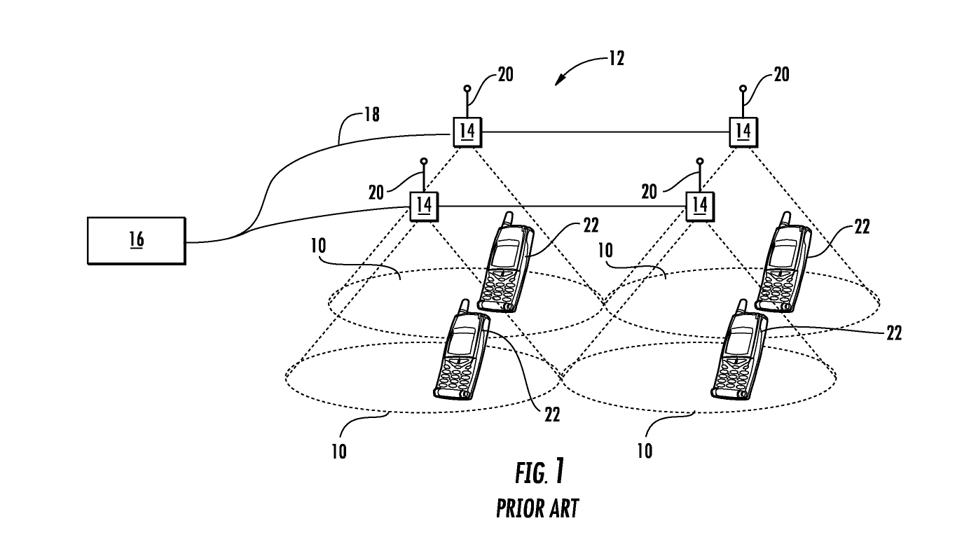

Before discussing the DCBU and related embodiments, a conventional wireless system is illustrated in FIG. 1. Coverage areas 10 in a DAS 12 are created by and centered on remote units (RUs) 14 connected to a head-end equipment 16 (e.g., a head-end controller, a head-end unit (HEU), or a central unit). The RUs 14 receive wireless communications services from the HEU 16 over a communications medium 18 to be distributed in a respective coverage area 10. The RUs 14 include information processing electronics, an RF transmitter/receiver, and an antenna 20 operably connected to the RF transmitter/receiver to wirelessly distribute the wireless communications services to wireless client devices 22 within the coverage area 10. The size of a given coverage area 10 is determined by the amount of RF power transmitted by the RU 14, receiver sensitivity, antenna gain, and RF environment, as well as by the RF transmitter/receiver sensitivity of the wireless client device 22. Wireless client devices 22 usually have a fixed RF receiver sensitivity, so that the above-mentioned properties of the RU 14 mainly determine the size of the coverage area 10.

In wireless/cellular networks, such as the DAS 12 in FIG. 1, each communications medium 18 has a maximum rated bandwidth over a given distance. In some conventional DASs, high-bandwidth optical fiber is used as the communications medium 18 throughout the DAS 12. In other conventional systems, communications medium 18 may be a lower bandwidth copper-based medium, such as coaxial cable. In these systems, high bandwidth RF communications signals received by the HEU 16 may be downshifted to IFs that can carry the same data within the smaller bandwidth of the copper-based medium. Each IF can be upshifted back to the original RF communications signal by the respective RUs 14 that receive the IFs.

In many conventional DASs, such as the DAS 12 of FIG. 1, the IF for each corresponding RF communications signal is predetermined when configuring the DAS 12. The parameters for producing the selected IFs are thus hard-wired in advance or may manually programmed into the HEU 16. In addition, each IF is generally static during operation of the DAS 12. To the extent that reconfiguring the arrangement of IFs within the total bandwidth of the communications medium 18 is possible, such reconfiguration requires manipulation of system settings by a user or administrator.

Many conventional DASs 12 are designed to simultaneously support multiple frequency bands (e.g. 700 MHz, 850 MHz, 1900 MHz). These DASs 12 usually transfer several active channels within each frequency band as well. The frequency bands are significantly wider than the actual required bandwidth for the transfer of the active channels at any given time. To transfer a complete band, the DAS 12 must support a frequency range equal to the sum of the supported frequency bands, as if the IF is using the entire frequency range (i.e., operating at maximum bandwidth) at all times. During periods of non-peak activity, a large portion of the bandwidth between bands is unused, and the usage profile of each band might also change over time. Thus, it can be seen that conventional IF shifting methods do not efficiently allocate bandwidth. This problem becomes particularly acute with relatively low bandwidth copper-based communications mediums 18.

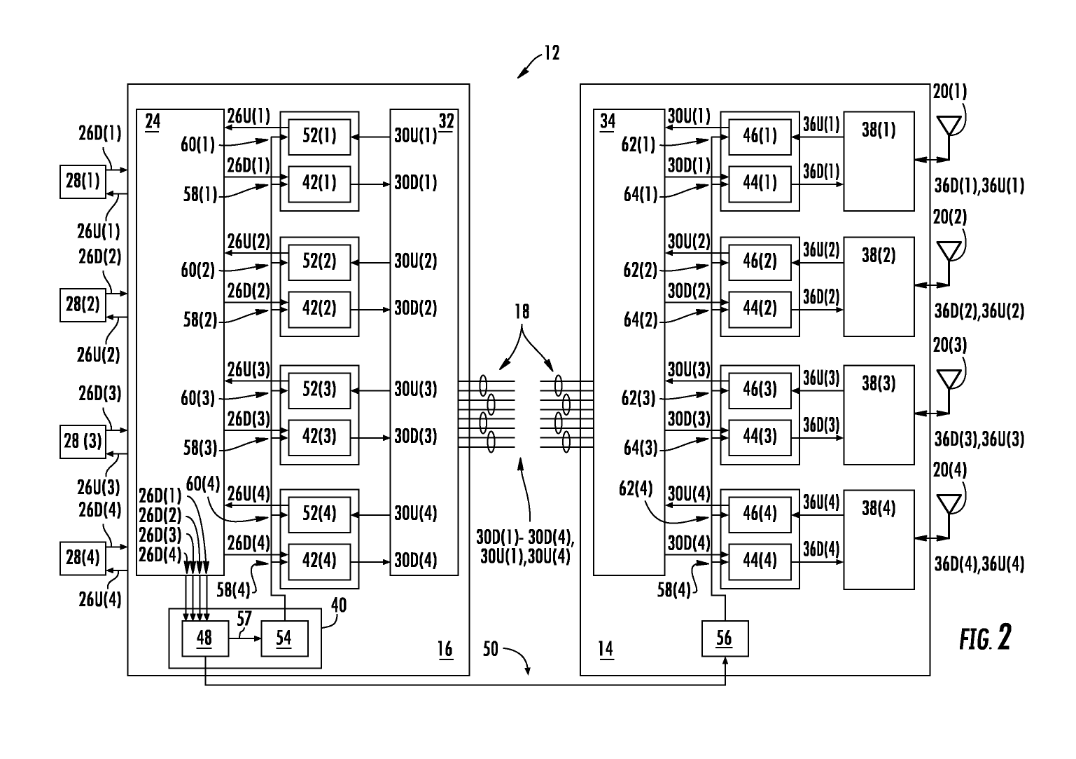

According to one aspect of the present embodiments, bandwidth is optimized by identifying the existence, the location, and the bandwidth of the active channels, and by dynamically arranging those active channels in a way that minimizes the bandwidth used by the communications medium 18. FIG. 2 is a schematic diagram of an exemplary multi-band radio band distributed RF antenna system 12 employing a DBCU (not shown) for providing dynamically shifted RF communications services. As illustrated in FIG. 2, the distributed RF antenna system 12 and its components could be configured to provide any number of radio bands, as desired. The notations (1)-(4) signify common elements, but four (4) of the elements are provided, each for supporting a radio band among the four radio bands in this example. Where the notations (1)-(4) are omitted in this description, any one or more of the elements may be referred to. It should therefore be understood that any combination of radio bands may be created (e.g., dual band, quadro band etc.).

The distributed RF antenna system 12 is configured to create one or more antenna coverage areas 10 for establishing communications with wireless client devices 22 located in the RF range of the antenna coverage areas 10 created by RUs 14. The RUs 14 may also be termed “remote antenna units” if they contain one or more antennas to support wireless communications. The system 12 provides any type of RF communications services desired, for example cellular radio services as a non-limiting example. In this embodiment, the system 12 includes head-end equipment, such as the HEU 16, one or more RUs 14, and a communications medium 18 that communicatively couples the HEU 16 to the RU 14. The HEU 16 is configured to provide RF communication services to the RU 14 for wireless propagation to wireless client devices 22 in communication range of an antenna 20 of the RU 14. The RU 14 may also be configured to support wired communications services. Note that although only one RU 14 is illustrated as being communicatively coupled to the HEU 16 in FIG. 1, a plurality of RUs 14 can be communicatively coupled to the HEU 16 to receive RF communication services from the HEU 16. The system 12 can be deployed in a building infrastructure (not shown), having two, three, or more floors, with multiple RUs 14 located on each floor of the infrastructure.

With continuing reference to FIG. 2, the HEU 16 includes a radio interface 24 (or RF interface) that is configured to receive downlink RF communications signals 26D for RF communications services to be provided to the RU 14. The RF communications service may be a cellular radio service or any other type of RF communications service. The radio interface 24 receives the downlink RF communications signals 26D (26D(1)-26D(4) in this example) to be provided to the RU 14 from a base transceiver station (BTS) 28. As will be discussed in more detail below, the HEU 16 is configured to provide downlink RF signals 30D (based on downlink RF communications signals 26D) through a communications interface 32 to provide the RF communications services based on the downlink RF communications signals 26D over a communications medium 18 to the RU 14. The communications interface 32 could include a cable interface that interfaces with a cable medium (e.g., coaxial cable, fiber optic cable) for sending and receiving communications signals.

The RU 14 includes a communications interface 34 configured to receive downlink RF communications signals 36D (36D(1)-36D(4) in this example) and provide downlink RF communications signals 36D providing the RF communications services to an antenna interface 38. The antenna 20, which is electrically coupled to the antenna interface 38, is configured to wirelessly radiate the downlink RF communications signals 36D to wireless client devices 22 in wireless communication range of the antenna 20. The communications interface 34 could include a cable interface that interfaces with a cable medium (e.g., coaxial cable, fiber optic cable) for sending and receiving communications signals, including the downlink RF communications signals 36D.

In this embodiment, the HEU 16 also includes a dynamic bandwidth control unit (DBCU) 40 for shifting each of the “native” downlink RF communications signals 26D into respective “shifted” downlink RF signals 30D, also referred to herein as downlink IF signals 30D. In some embodiments, the downlink RF communications signals 26D are passed by the DBCU 40 and remain the same signals as the downlink RF communications signals 26D. In this embodiment, as provided in the distributed RF antenna system 12 of FIG. 2, the downlink RF communications signals 26D are frequency shifted by down converter circuitry (DC) 42 of the DBCU 40 to provide downlink RF communications signals 36D. The downlink RF communications signals 26D are down converted to the downlink IF signals 30D (30D(1)-30D(4) in this example) to an IF different from (e.g., lower or higher than) the frequency of the downlink communications signals 26D. This permits the same amount of data to be transmitted over communications medium 18 within a smaller frequency band, thereby conserving bandwidth on communications medium 18.

To recover the downlink RF communications signals 26D at the RU 14 to be radiated by the antenna 20, an up converter circuitry (UC) 44 is provided in the RU 14 to up convert the downlink IF signals 30D to the downlink RF communications signals 36D. The downlink RF communications signals 36D are of the same or substantially the same frequency as the downlink RF communications signals 26D in this embodiment. The downlink RF communications signals 36D may be frequency locked to the downlink RF communications signals 26D. The downlink RF communications signals 36D may be phase locked to the downlink RF communications signals 26D, such as through a phase locked loop (PLL) circuit in a complementary UC 44, as another non-limiting example.

With continuing reference to FIG. 2, the radio interface 24 is also configured to receive uplink RF communications signals 26U (26U(1)-26U(4) in this example) to provide uplink communications received at the RU 14 from the wireless client devices 22 to the HEU 16. The radio interface 24 receives the uplink RF communications signals 36U (36U(1)-36U(4) in this example) from the RU 14 via the communications interfaces 32, 34 in the RU 14 and HEU 16, respectively. The RU 14 is configured to provide the uplink IF signals 30U (30U(1)-30U(4) in this example) through the communications interface 34 to provide uplink communications for the RF communications services over the communications medium 18 to the communications interface 32 of the HEU 16. The uplink IF signals 30U are based on the uplink RF communications signals 36U received by the antenna 20 of the RU 14 from the wireless client devices 22. The uplink RF communications signals 36U may be the same signals as the downlink RF communications signals 36D.

The uplink RF communications signals 36U are frequency shifted by DC 46 in the RU 14 to provide uplink IF signals 30U. The uplink RF communications signals 36U are down converted to the uplink IF signals 30U to an IF that is different from the frequency of uplink RF communications signals 36U. In this embodiment, as will be discussed in greater detail below, a channel identifier 48 disposed in the DBCU 40 generates a management signal 50 that controls the remote side UCs 44 and DCs 46. To recover the uplink RF communications signals 36U at the HEU 16 to be provided to the BTS 28, a UC 52 is provided in the HEU 16 to up convert the uplink IF signals 30U to the uplink RF communications signals 26U. In this embodiment, the uplink RF communications signals 26U are of the same or substantially the same frequency as the uplink RF communications signals 36U. The uplink RF communications signals 26U may be frequency locked to the uplink RF communications signals 36U. The signals 26U may be phase locked to the uplink RF communications signals 36U, such as through a PLL circuit in the UC 44, as another non-limiting example.

Although FIG. 2 shows the DCs 42, 46 in the downlink communications paths to down convert the downlink signals 26D, 36D, and the UCs 44, 52 in the uplink communications path to up convert the uplink signals 26U, 36U, the reverse configuration could be employed. That is, the UCs 44, 52 could be provided in the downlink communications path to up convert the downlink RF communications signals 26D, 36D, and the DCs 42, 46 could be provided in the uplink communications path to down convert the uplink RF communications signals. These frequency conversion circuitries can be also referred to generally as first, second, third, etc. frequency conversion circuitries.

The communications medium 18 in the distributed RF antenna system 12 could be any number of media. For example, the communications medium 18 may be an electrical conductor, such as twisted-pair wiring or coaxial cable. Frequency division multiplexing (FDM) or time division multiplexing (TDM) can be employed to provide RF communications signals between the HEU 16 and multiple RUs 14, which are communicatively coupled to the HEU 16 over the same communications medium 18. Alternatively, separate, dedicated communications medium 18 may be provided between each RU 14 and the HEU 16. The UCs 44, 52, and DCs 42, 46 in the RUs 14 and the HEU 16 could be provided to frequency shift at different IFs to allow RF communications signals from multiple RUs 14 to be provided over the same communications medium 18 without interference in RF communications signals (e.g., if different codes or channels are not employed to separate signals for different users).

Also, for example, the communications medium 18 may have a lower frequency handling rating than the frequency of the RF communications service. In this regard, the down conversion of the downlink and uplink RF communications signals 26D, 26U frequency shifts the signals to an IF that is within the frequency rating of the communications medium 18. The communications medium 18 may have a lower bandwidth rating than the bandwidth requirements of the RF communications services. Thus, again, the down conversion of the downlink and uplink RF communications signals 26D, 26U can frequency shift the signals to an IF that provides a bandwidth range within the bandwidth range of the communications medium 18. For example, the distributed RF antenna system 12 may be configured to use an existing communications medium 18 for other communications services, such as digital data services (e.g., WLAN services). For example, the communications medium 18 may be Category 5, 6, or 7 (i.e., CAT 5, CAT 6, CAT 7) conductor cable that is used for wired services, such as Ethernet-based LAN as a non-limiting example. In this example, down conversion ensures that the downlink and uplink RF communications signals 36D, 36U can be properly communicated over the communications medium 18 with acceptable signal attenuation.

Synthesizer circuits 54, 56 in the HEU 16 and the RU 14, respectively, provide RF reference signals for frequency conversion by the DCs 42, 46 and the UCs 44, 52. The synthesizer circuit 54 is provided in the DBCU 40 of the HEU 16 and is controlled via a synthesizer control signal 57 received from the channel identifier 48. The synthesizer circuit 54 in the HEU 16 provides one of more local oscillator (LO) signals 58 to the DC 42 for frequency shifting the downlink RF communications signals 26D to the downlink RF communications signals 36D at a different IF. The synthesizer circuit 54 also provides one of more LO signals 60 to the UC 52 for frequency shifting the uplink RF communications signals 36U from the IF to the frequency of the RF communications services to provide the uplink RF communications signals 26U.

In this embodiment, the DBCU 40 dynamically shifts the active downlink RF communications signals 26D to different IF signals 30D as needed, for example, to use a narrower portion of the total bandwidth of the communications medium 18. Each DBCU 40 includes a channel identifier 48 configured to detect the presence of each downlink RF communications signal 26D. The channel identifier 48 continuously scans the active bands of the distributed RF antenna system 12, for example, by detecting the downlink RF communications signals 26D being served to the radio interface 24. The channel identifier 48 also determines relevant properties of each downlink RF communications signal 26D, such as a center frequency and bandwidth of each downlink RF communications signal 26D. The channel identifier 48 then dynamically assigns a downlink IF signal 30D for each downlink RF communications signal 26D such that at least one downlink IF signal 30D is based on another of the selected downlink IF signals 30D. In this example, the DBCU 40 selects a first downlink IF signal 30D and sequentially assigns each subsequent downlink IF signal 30D based on the previous adjacent downlink IF signal 30D. In this manner, the downlink IF signals 30D can be “stacked”, i.e., arranged, as close to each other as possible without interfering with each other, within a relatively narrow portion of the total bandwidth of the communications medium 18.

Thus, in this example, the “native bandwidth” (i.e., rated capacity) of a given communications medium 18 is more fully utilized. The channel identifier 48 of the DBCU 40 dynamically changes the arrangement of the IF channels periodically or in real time, based on the channel identifier's 48 continuous monitoring of the active channels of the distributed RF antenna system 12. Thus, any change in service on one or more channels can be detected by the DBCU 40 and the plurality of downlink IF signals 30D can be dynamically rearranged in real time to optimize bandwidth usage on the communications medium 18. One advantage of this arrangement is that it is not required to pre-set or hard-wire the distributed RF antenna system 12 to a static channel configuration, which must be changed manually whenever there is a change in service from the service provider.

The channel identifier 48 also generates a management signal 50 that is transmitted to each RU 14. The management signal 50 instructs the synthesizer circuit 54 of each RU 14 to generate a plurality of LO signals 58 based on each selected IF signal 30D. Each LO signal 58 is then transmitted to a respective DC 42, where the LO signal 58 is mixed with the respective downlink RF communications signal 26D to generate downlink IF signal 30D. In this manner, each downlink RF communications signal 26D is downshifter into the downlink IF signal 30D selected by the channel identifier 48.

In one embodiment, the channel identifier 48 instructs the synthesizer circuits 54 and/or 56 based on a lookup table (not shown). The lookup table can include all possible combinations of downlink RF communications signals 26D for a given hardware configuration of the system 12. When the channel identifier 48 identifies the configuration of downlink RF communications signals 26D, the channel identifier 48 then selects a predetermined configuration for the plurality of downlink IF signals 30D from the lookup table. As the configuration of downlink RF communications signals 26D changes over time, the channel identifier 48 dynamically updates the location and arrangement for the plurality of downlink IF signals 30D from the lookup table in real time.

In this embodiment, the management signal 50 also instructs the synthesizer circuit 56 to downshift the corresponding uplink RF communications signals 26U to the same uplink IF signals 30U as the corresponding downlink IF signals 30D. The synthesizer circuit 54 can then upshift each uplink IF signal 30U back to respective uplink RF communications signals 26U that are the same as the “native” uplink RF communications signals 36U, and that correspond to the “native” downlink RF communications signals 26D.

As one example, the LO signals 58, 60 generated by synthesizer circuit 56 may be directly provided to mixers in the DC 42 and UC 52 to control generation of mixing RF signals (not shown) to be mixed with the downlink RF communications signals 26D and the uplink RF communications signals 36U, respectively, for frequency shifting. The LO signals 58, 60 may be provided to control other circuitry that provides signals to control the mixers in the DC 42 and the UC 52. Oscillators (not shown) in the DC 42 and the UC 52 generate mixing RF signals to be mixed with the downlink RF communications signals 26D and the uplink RF communications signals 36U, respectively, for frequency shifting.

The synthesizer circuit 56 in the RU 14 provides one or more LO signals 62 to the DC 46 for frequency shifting the uplink RF communications signals 36U to the uplink RF communications signals 36U at a different IF. The synthesizer circuit 56 also provides one or more LO signals 64 to the UC 44 for frequency shifting the downlink RF communications signals 36D from the IF to the frequency of the RF communications services to provide the uplink RF communications signals 36U. As a non-limiting example, the LO signals 62, 64 are directly provided to mixers in the DC 46 and UC 44 to control generation of mixing RF signals (not shown) to be mixed with the downlink RF communications signals 36D and the uplink RF communications signals 36U, respectively, for frequency shifting. As another non-limiting example, the LO signals 62, 64 are not provided directly to mixers in the DC 46 and UC 44. The LO signals 62, 64 may be provided to control other circuitry that provides signals to control the mixers in the DC 46 and the UC 44. The oscillators in the synthesizer circuit 56 and the UC 44 generate mixing RF signals to be mixed with the downlink RF communications signals 36D and the uplink RF communications signals 36U, respectively, for frequency shifting.

The HEU 16 may be configured to support any frequencies desired, including but not limited to US FCC and Industry Canada frequencies (824-849 MHz on uplink and 869-894 MHz on downlink), US FCC and Industry Canada frequencies (1850-1915 MHz on uplink and 1930-1995 MHz on downlink), US FCC and Industry Canada frequencies (1710-1755 MHz on uplink and 2110-2155 MHz on downlink), US FCC frequencies (698-716 MHz and 776-787 MHz on uplink and 728-746 MHz on downlink), EU R & TTE frequencies (880-915 MHz on uplink and 925-960 MHz on downlink), EU R & TTE frequencies (1710-1785 MHz on uplink and 1805-1880 MHz on downlink), EU R & TTE frequencies (1920-1980 MHz on uplink and 2110-2170 MHz on downlink), US FCC frequencies (806-824 MHz on uplink and 851-869 MHz on downlink), US FCC frequencies (896-901 MHz on uplink and 929-941 MHz on downlink), US FCC frequencies (793-805 MHz on uplink and 763-775 MHz on downlink), and US FCC frequencies (2495-2690 MHz on uplink and downlink), medical telemetry frequencies, and WLAN frequencies. Further, the HEU 16 may be configured to support frequency division duplexing (FDD) and time divisional duplexing (TDD).

An exemplary RU 14 may be configured to support up to four (4) different radio bands/carriers (e.g. ATT, VZW, TMobile, Metro PCS: 700LTE/850/1900/2100). Radio band upgrades can be supported by adding remote expansion units over the same communications medium 18 (or upgrade to multiple-in/multiple-out (MIMO) on any single band). The RUs 14 and/or remote expansion units may be configured to provide external filter interface to mitigate potential strong interference at 700 MHz band (Public Safety, CH51,56); Single Antenna Port (N-type) provides DL output power per band (Low bands (<1 GHz): 14 dBm, High bands (>1 GHz): 15 dBm); and satisfies the UL System RF spec (UL Noise Figure: 12 dB, UL IIP3: −5 dBm, UL AGC: 25 dB range).

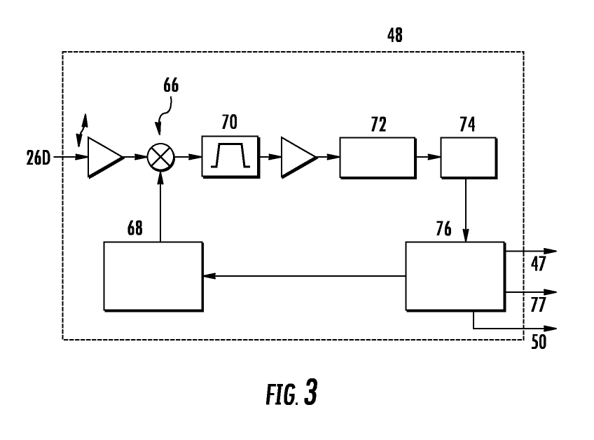

Channel identifier 48 can be implemented by appropriate hardware and/or software. In this regard, FIG. 3 illustrates a schematic diagram of an implementation of the channel identifier 48 of FIG. 2 according to an exemplary embodiment. The channel identifier 48 continuously scans the frequency band by feeding the downlink RF communications signals 26D to a mixer 66. A variable local oscillator 68 is configured to oscillate in a range of frequencies (LO) between ±RFₘᵢₙ±IF to ±RFₘₐₓ±IF, where RFₘᵢₙ is the lower frequency of each RF band in use and RFₘₐₓ is the higher frequency of each RF band in use.

The output of the mixer 66 produces an IF signal IF=±RF±LO. The specific IF frequency is determined by the center frequency of a band pass filter 70. The IF signal is next filtered by the band pass filter 70 and is then fed to a power detector 72. The power detector 72 determines the power level of the detected signal. This determined power level is then provided in analog form to an analog-to-digital converter (ADC) 74, which translates the analog power level to a digital format and provides it to a micro-controller 76.

The micro-controller 76 accumulates data from the RF frequency bands, including the frequency and the bandwidth of each active channel. Based on this data, the micro-controller 76 determines the frequency shift required by each DC 42 and provides this data to synthesizer circuit 54 via synthesizer control signal 47. In some embodiments, all the information required to produce the downlink IF signals 30D is contained in the synthesizer control signal 47 and is provided to the DCs 42 by the synthesizer circuit 54 as part of or alongside the LO signal 58. An additional filter management signal 77 can be provided from the channel identifier 48 directly to the DCs 42 to further control components of the DCs 42 such as filters, amplifiers, and other components of the DCs 42.

The information on the frequency shift and the bandwidth of the RF channel is transferred to the synthesizer circuits 56 of the RUs 14 via the management signal 50, where the IF band channels are up converted by UCs 44. The channel identifier 48 and management signal 50 can also adjust the uplink DCs 46 and UCs 52 accordingly as well.

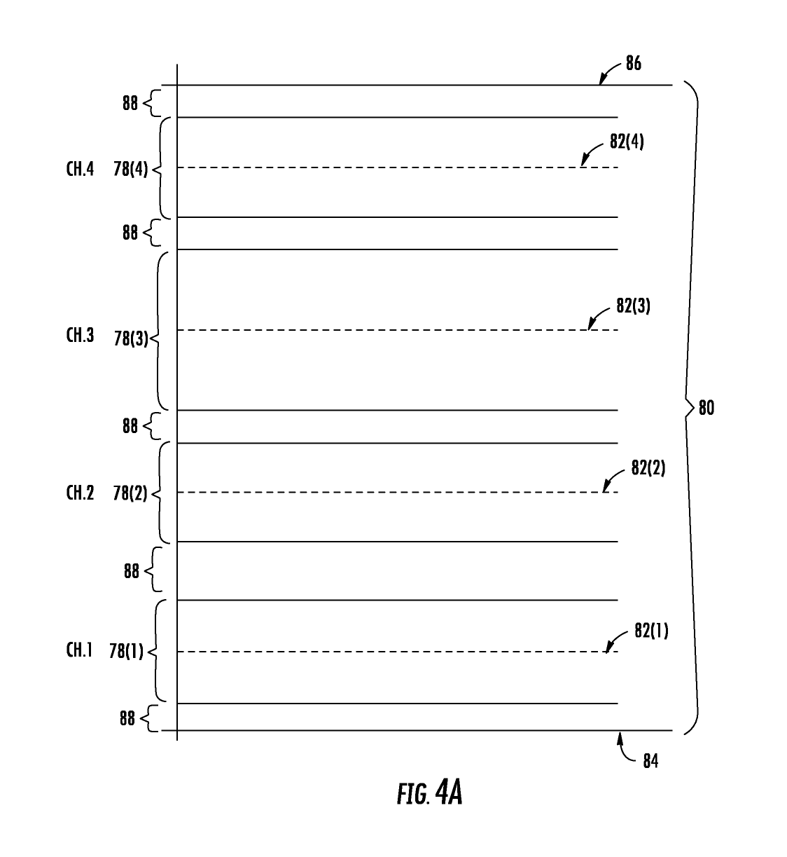

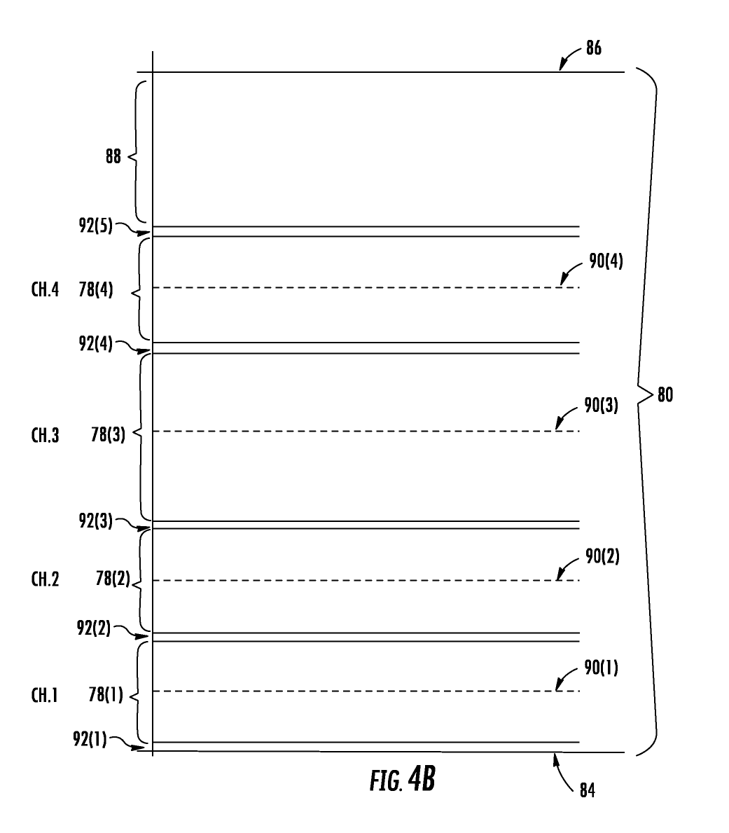

FIG. 4A illustrates bandwidth usage in a conventional multiple radio band distributed communications system. In FIG. 4A, four IF signals 78 are transmitted over an 8 MHz band 80 of the system communications medium. Each IF signal 78 has 2 MHz of dedicated bandwidth with center frequencies 82 evenly spaced between lower and upper boundaries 84, 86 of the 8 MHz band 80. However, in most cases, only a small subset of IF signals utilize their entire allocated bandwidth. As shown in FIG. 4A, only channel 3 (IF signal 78(3)) utilizes a full 2 MHz, while channels 1, 2, and 4 (IF signals 78(1), 78(2), 78(4)) are 1.25 MHz channels. Thus, although channels 1-4 only require a total of 5.75 MHz of bandwidth, five unused portions 88 of the 8 MHz band 80, totaling 2.25 MHz of bandwidth, are not available.

FIG. 4B is a graphical representation of bandwidth usage by an exemplary multiple radio band distributed RF communications system, such as the DAS 12, employing a DBCU 40 (not shown) for providing dynamically shifted RF communications services to RUs 14. Similar to the arrangement of FIG. 4A, channels 1-4 (IF signals 78) are arranged within the same 8 MHz band 80 of the communications medium 18. In this example, however, the DBCU 40 has dynamically shifted each IF signal 78 based on the location and bandwidth of the other IF signals 78. The DBCU 40 selects a center frequency 90(1) for IF signal 78(1) such that the bandwidth of IF signal 78(1) is adjacent to the lower boundary 84 of the 8 MHz band 80. The bandwidth of IF signal 78(1) can abut the lower boundary 84 of the 8 MHz band 80 or, as in this example, can be arranged to abut a predetermined buffer band 92(1) to prevent interference or signal loss.

In this example, a buffer band 92(1) of 100 kilohertz (kHz) is located at the lower boundary 84 of the 8 MHz band 80 of the communications medium 18, and the center frequency 90(1) of the IF signal 78(1) is selected to be fₘᵢₙ+725 kHz, where fₘᵢₙ is the lower boundary 84 of the 8 MHz band 80, such that the bandwidth of the IF signal 78(1) abuts the buffer band 92(1). The center frequency 90(2) of IF signal 78(2) is then selected such that the IF signal 78(2) abuts another buffer band 92(2) between IF signals 78(1) and 78(2). The center frequency 90(3) of IF signal 78(3) is selected such that the IF signal 78(3) abuts buffer band 92(3) between IF signals 78(2) and 78(3), and so on. Accordingly, the center frequencies 90 of IF signals 78 are arranged such that the IF signals 78 and buffer bands 92 are contained within a 6.25 MHz portion of the 8 MHz band 80, leaving a single unused portion 88 of the 8 MHz band 80 of 2.75 MHz. Thus, an additional 1.25 MHz channel can be transmitted within the 8 MHz band 80 of communications medium 18 without interfering with the other IF signals 78.

The channel identifier 48 can dynamically calculate a center frequency 82, 90 for each IF signal 78, based on the total bandwidth available, the location and bandwidth of each channel, and on the desired spacing between adjacent channels. In this example, the calculation of each center frequency f_{c} is be represented by Equations 1-4 below:

f_{c}(1)=fₘᵢₙ+f_{buffer}+f_{b}(1)/2 Equation 1:

f_{c}(2)=f_{c}(1)+f_{b}(1)/2+f_{buffer}+f_{b}(2)/2 Equation 2:

f_{c}(3)=f_{c}(2)+f_{b}(2)/2+f_{buffer}+f_{b}(3)/2 Equation 3:

f_{c}(4)=f_{c}(3)+f_{b}(3)/2+f_{buffer}+f_{b}(4)/2 Equation 4:

In the above Equations 1-4, fₘᵢₙ is the lower boundary 84 of the 8 MHz band 80, f_{buffer} is the predetermined buffer band 92 bandwidth, f_{b}(N) is the bandwidth of a given IF signal 78(N), and f_{c}(N) is the center frequency 82, 90 of a given IF signal 78(N). It is also possible to vary any number of parameters as needed. For example, when more bandwidth is needed, the bandwidth of one or more buffer bands 92 can be dynamically reduced. On the other hand, if it is determined that two or more IF signals 78 are interfering with each other, the bandwidth of one or more buffer frequencies can be dynamically increased. In this manner, the full bandwidth of any given communications medium 18 can be utilized.

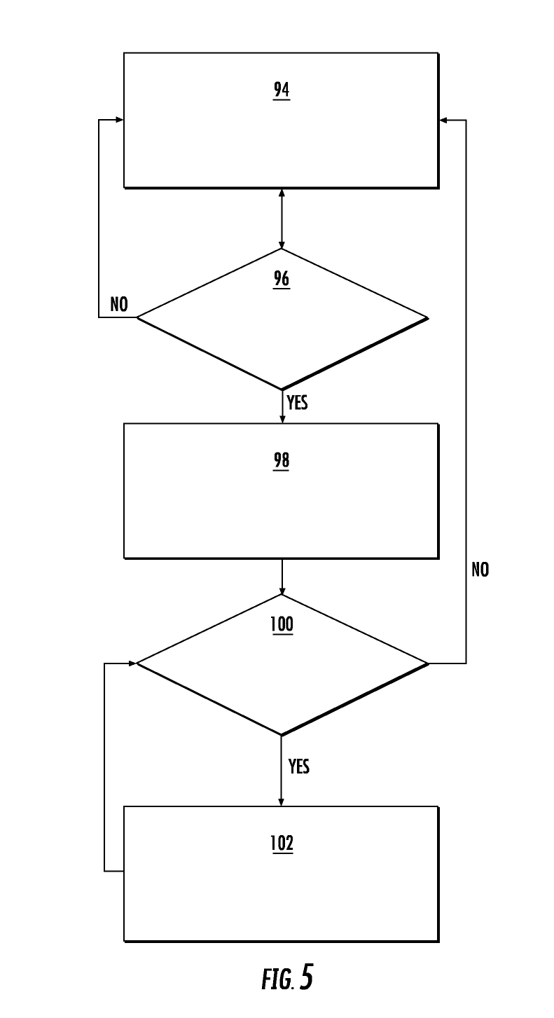

FIG. 5 illustrates a flowchart diagram of a method of operating a DBCU 40 according to an exemplary embodiment. First, the number, location, and bandwidth of the RF communications signals are identified (block 94). Next, it is determined whether any of the relevant properties of the RF communications signals have changed (block 96). If there is no change, the process returns to block 94. If there has been a change, the first RF communications signal is assigned to an IF signal (block 98), for example, based on the boundaries of the bandwidth of the relevant communications medium. It is then determined whether all RF communications signals have been assigned to an IF signal (block 100). If all RF communications signals have not been assigned, the next RF communications signal is assigned to an IF signal based on the previously assigned IF signal (block 102). For example, the center frequency of the IF signal can be assigned based on the bandwidth of the IF signal and the previous IF signal, and on the center frequency of the previous IF signal. The process then returns to block 100. Once all the RF communications signals have been assigned to an IF signal, the process returns to block 94.

It may be desirable to provide both digital data services and RF communications services for wireless client devices in a DAS that employs an automatic antenna selection arrangement for providing both types of services simultaneously. Examples of digital data services include, but are not limited to, Ethernet, WLAN, WiMax, WiFi, Digital Subscriber Line (DSL), and LTE, etc. Ethernet standards could be supported, including but not limited to 100 Megabits per second (Mbs) (i.e., fast Ethernet) or Gigabit (Gb) Ethernet, or ten Gigabit (10G) Ethernet. Examples of digital data devices include, but are not limited to, wired and wireless servers, wireless access points (WAPs), gateways, desktop computers, hubs, switches, remote radio heads (RRHs), baseband units (BBUs), and femtocells. A separate digital data services network can be provided to provide digital data services.

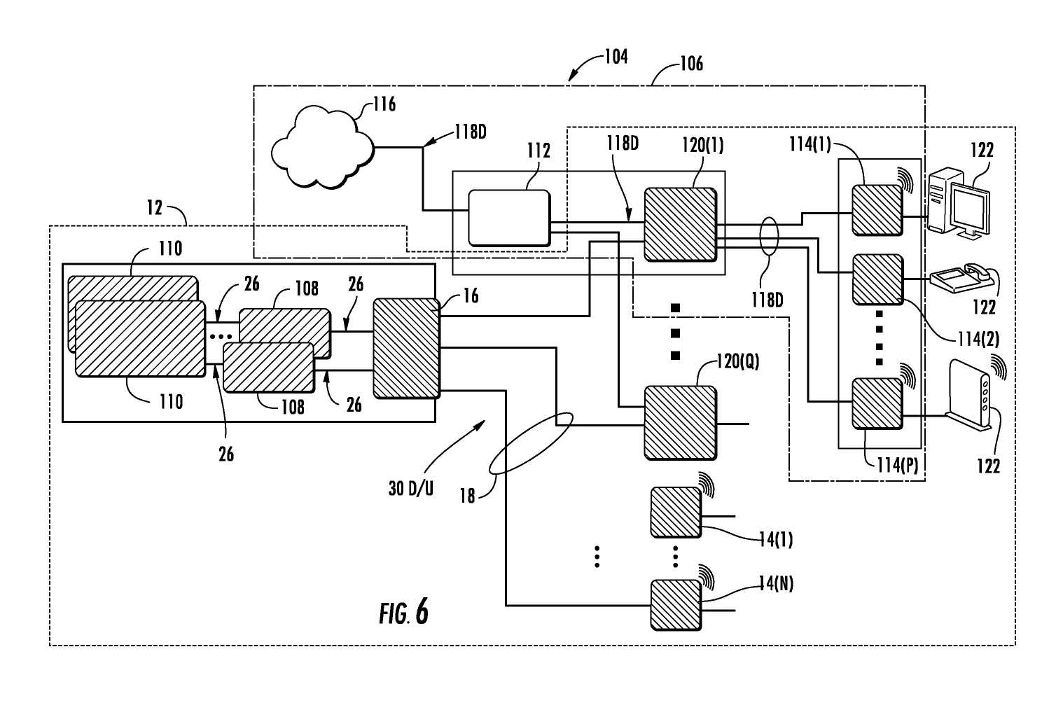

In this regard, FIG. 6 is a schematic diagram of an exemplary distributed antenna system 104 that includes the distributed RF communications system 12 in FIG. 2 and a wireless local access network (WLAN) system 106 for providing digital data services. The distributed RF antenna system 12 includes the HEU 16 previously described above with regard to FIG. 2. The HEU 16 is configured to receive the downlink RF communications signals 26D through downlink/uplink interfaces 108 from one or more base stations 110. The HEU 16 can be configured to receive RF communications services from the one or more base stations 110 to support multiple RF radio bands in the DAS 12. The HEU 16 is also configured to provide the downlink RF communications signals 36D to the RUs 14(1)-14(N), and receive the uplink RF communications signals 36U from RUs 14(1)-14(N) over the communications medium 18. In this example, the HEU 16 includes a DBCU 40 (not shown) for dynamically shifting the downlink RF communications signals 26D into IF signals 30D for transmission over the communications medium 18. M number of RUs 14 signifies that any number, M number, of RUs 14 could be communicatively coupled to the HEU 16, as desired.

With continuing reference to FIG. 6, a digital data switch 112 may also be provided in the WLAN system 106. The digital data switch 112 may be provided in the WLAN system 106 for providing digital data signals, such as for WLAN services for example, to RUs 114(1)-114(P) configured to support digital data services, wherein P signifies that any number of the RUs 114 may be provided and supported by the WLAN system 106. The digital data switch 112 may be coupled to a network 116, such as the Internet. Downlink digital data signals 118D from the network 116 can be provided to the digital data switch 112. The downlink digital data signals 118D can then be provided to the RUs 114(1)-114(P) through slave central units 120(1)-120(Q), wherein Q can be any number desired. The digital data switch 112 can also receive uplink digital data signals 118U from the RUs 114(1)-114(P) to be provided back to the network 116. The slave central units 120(1)-120(Q) also receive the downlink RF communications signals 36D and provide uplink RF communications signals 36U from the RUs 114(1)-114(P) to the HEU 16 in this embodiment. The RUs 114(1)-114(P), by being communicatively coupled to a slave central unit 120(1) that supports both the RF communications services and the digital data services, is included in both the distributed RF antenna system 12 and the WLAN system 106 to support RF communications services and digital data services, respectively, with client devices 122(1)-122(P). For example, such RU 114 may be configured to communicate wirelessly with the WLAN user equipment (e.g., a laptop) and Wide Area Wireless service user equipment (e.g., a cellular phone).

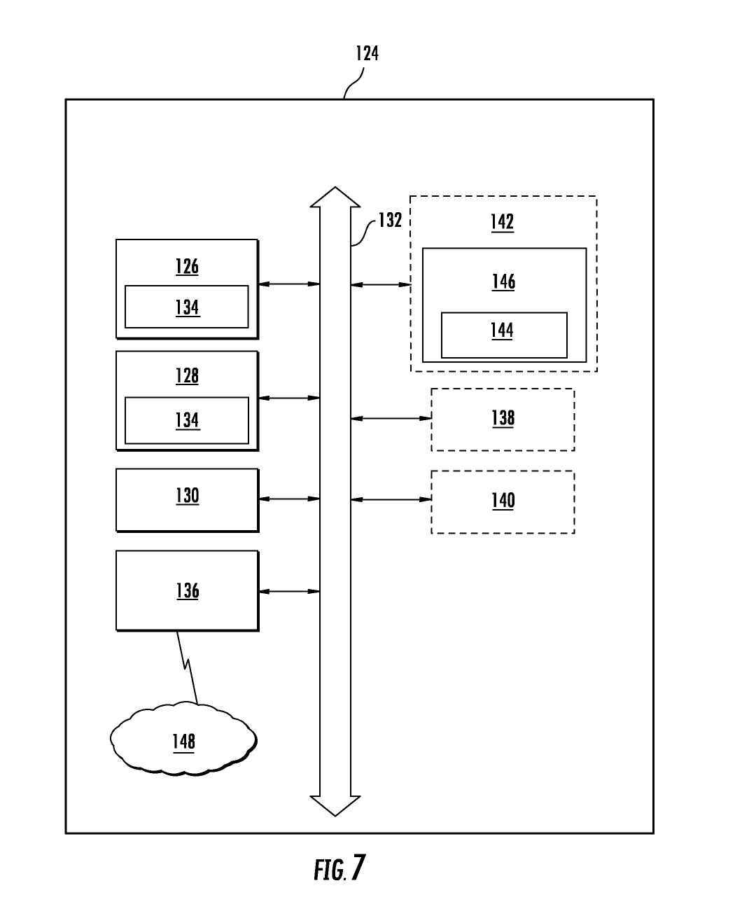

Any of the DAS components disclosed herein can include a computer system. FIG. 7 is a schematic diagram representation of additional detail regarding an exemplary form of an exemplary computer system 124 including a set of instructions for causing the DAS component(s) to provide its designed functionality. The DAS component(s) may be connected (e.g., networked) to other machines in a LAN, an intranet, an extranet, or the Internet. The DAS component(s) may operate in a client-server network environment, or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The DAS component(s) may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server or a user's computer. The exemplary computer system 124 includes a processing device or processor 126, a main memory 128 (e.g., read-only memory (ROM), flash memory, dynamic random access memory (DRAM) such as synchronous DRAM (SDRAM), etc.), and a static memory 130 (e.g., flash memory, static random access memory (SRAM), etc.), which may communicate with each other via a data bus 132. Alternatively, the processing device 126 may be connected to the main memory 128 and/or static memory 130 directly or via some other connectivity means. The processing device 126 may be a controller, and the main memory 128 or static memory 130 may be any type of memory, each of which can be included in the HEU 16 of FIG. 2.

The processing device 126 represents one or more general-purpose processing devices such as a microprocessor, central processing unit, or the like. More particularly, the processing device 126 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 126 is configured to execute processing logic in instructions 134 (located in the processing device 126 and/or the main memory 128) for performing the operations and steps discussed herein.

The computer system 124 may further include a network interface device 136. The computer system 124 also may include an input 138 to receive input and selections to be communicated to the computer system 124 when executing instructions. The computer system 124 also may include an output 140, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 124 may include a data storage device 142 that includes instructions 144 stored in a computer-readable medium 146. The instructions 144 may also reside, completely or at least partially, within the main memory 128 and/or within the processing device 126 during execution thereof by the computer system 124, the main memory 128 and the processing device 126 also constituting the computer-readable medium 146. The instructions 134, 144 may further be transmitted or received over a network 148 via the network interface device 136.

While the computer-readable medium 146 is shown in an exemplary embodiment to be a single medium, the term “computer-readable medium” should be taken to include a single medium or multiple media (e.g., a centralized or distributed database, and/or associated caches and servers). The term “computer-readable medium” shall also include any medium that is capable of storing, encoding or carrying a set of instructions for execution by the processing device and that cause the processing device to perform any one or more of the methodologies of the embodiments disclosed herein. The term “computer-readable medium” shall accordingly be taken to include solid-state memories, optical and magnetic medium, and carrier wave signals.

The embodiments disclosed herein include various steps that may be performed by hardware components or embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., read only memory (“ROM”), random access memory (“RAM”), magnetic disk storage medium, optical storage medium, flash memory devices, etc.).

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

Further, as used herein, it is intended that terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

We claim:

1. A dynamic bandwidth control unit (DBCU) for controlling frequency conversion of radio frequency (RF) communications signals in a distributed antenna system (DAS) configured to:
identify a plurality of RF communications signals;
sequentially assign an intermediate frequency (IF) for each of the plurality of RF communications signals, wherein assigning at least one IF is based on a previously assigned IF; and
determine a plurality of mixing frequencies for converting the plurality of RF communications signals into a plurality of IF signals.

2. The DBCU of claim 1, configured to assign the at least one IF based on the previously assigned IF comprises, for each IF, by being configured to:
determine a bandwidth requirement for the IF;
determine a center frequency and a bandwidth of the previously assigned IF;
determine the center frequency for the IF based on the bandwidth requirement for the IF, and on the center frequency and the bandwidth of the previously assigned IF; and
assign the IF based on the center frequency of the IF and the bandwidth requirement for the IF.

3. The DBCU of claim 1, configured to assign the at least one IF based on the previously assigned IF by being configured to assign each IF based on a previously assigned IF adjacent to each IF.

4. The DBCU of claim 1, configured to sequentially assign the IF for each of the plurality of RF communications signals results in each IF by being configured to separate each IF from each adjacent IF by a minimum bandwidth.

5. The DBCU of claim 1, further configured to generate a management signal to enable at least one device to convert the plurality of IF signals to the plurality of RF communications signals.

6. The DBCU of claim 5, wherein;
the RF communications signals are downlink RF communications signals;
the IF signals are downlink IF signals; and
the management signal enables the at least one device to convert a plurality of uplink RF communications signals corresponding to the plurality of downlink RF communications signals to a plurality of uplink IF signals corresponding to the plurality of downlink IF signals.

7. The DBCU of claim 1, wherein:
the RF communications signals are downlink RF communications signals;
the IF signals are downlink IF signals; and
the DBCU is further configured to assign each of a plurality of uplink IF signals corresponding to the plurality of downlink IF signals to a plurality of uplink RF communications signals corresponding to the plurality of downlink RF communications signals.

8. A method for controlling frequency conversion of radio frequency (RF) communications signals in a distributed antenna system (DAS), comprising:
identifying a plurality of RF communications signals;
sequentially assigning an intermediate frequency (IF) for each of the plurality of RF communications signals, wherein assigning at least one IF is based on a previously assigned IF; and
determining a plurality of mixing frequencies for converting the plurality of RF communications signals into a plurality of IF signals.

9. The method of claim 8, wherein assigning the at least one IF based on the previously assigned IF comprises, for each IF:
determining a bandwidth requirement for the IF;
determining a center frequency and a bandwidth of the previously assigned IF;
determining the center frequency of the IF based on the bandwidth requirement for the IF, and on the center frequency and the bandwidth of the previously assigned IF; and
assigning the IF based on the center frequency of the IF and the bandwidth requirement for the IF.

10. The method of claim 8, wherein assigning the at least one IF based on the previously assigned IF comprises assigning each IF based on a previously assigned IF adjacent to the IF.

11. The method of claim 8, wherein sequentially assigning the IF for each of the plurality of RF communications signals results in each IF being separated from each adjacent IF by a minimum bandwidth.

12. The method of claim 8, further comprising generating a management signal for enabling at least one device to convert the plurality of IF signals to the plurality of RF communications signals.

13. The method of claim 12, wherein;
the RF communications signals are downlink RF communications signals;
the IF signals are downlink IF signals; and
the management signal is further capable of enabling the at least one device to convert a plurality of uplink RF communications signals corresponding to the plurality of downlink RF communications signals to a plurality of uplink IF signals corresponding to the plurality of downlink IF signals.

14. The method of claim 8, wherein:
the RF communications signals are downlink RF communications signals;
the IF signals are downlink IF signals; and
the method further comprises assigning each of a plurality of uplink IF signals corresponding to the plurality of downlink IF signals to a plurality of uplink RF communications signals corresponding to the plurality of downlink RF communications signals.

15. A distributed antenna system (DAS) comprising:
a dynamic bandwidth control unit (DBCU) for controlling frequency conversion of radio frequency (RF) communications signals configured to:
identify a plurality of downlink RF communications signals;
sequentially assign a downlink intermediate frequency (IF) for each of the plurality of downlink RF communications signals, wherein assigning at least one downlink IF is based on a previously assigned downlink IF;
determine a plurality of mixing frequencies for converting the plurality of downlink RF communications signals into a plurality of downlink IF signals; and
generate a management signal containing information regarding the plurality of downlink RF communications signals and the plurality of downlink IF signals;
a head-end unit (HEU) associated with the DBCU configured to transmit the plurality of downlink IF signals; and
at least one remote unit (RU), each RU configured to:
receive the plurality of downlink IF signals; and
convert the plurality of downlink IF signals to the plurality of downlink RF communications signals.

16. The DAS of claim 15, wherein each RU is further configured to:
receive a plurality of uplink RF communications signals, each uplink RF communications signal corresponding to a downlink RF communications signal;
convert the plurality of uplink RF communications signals to a plurality of uplink IF signals based on the management signal; and
transmit the plurality of uplink IF signals.

17. The DAS of claim 16, wherein the HEU is further configured to:
receive the plurality of uplink IF signals;
convert the plurality of uplink IF signals to the plurality of uplink RF communications signals based on the plurality of downlink RF communications signals.

18. The DAS of claim 16, wherein the DAS is deployed in at least three floors of a building infrastructure.

19. The DAS of claim 18, wherein each RU comprises an antenna assembly for transmitting downlink RF signals into a coverage area of the RU, and for receiving uplink communications from its coverage area.

20. The DAS of claim 19, wherein the at least one remote unit includes multiple RUs on each floor of the building infrastructure.

21. A non-transitory computer-readable medium comprising instructions for directing a processor to perform a method for controlling frequency conversion of radio frequency (RF) communications signals in a distributed antenna system (DAS), the method comprising:
identifying a plurality of RF communications signals;
sequentially assigning an intermediate frequency (IF) for each of the plurality of RF communications signals, wherein assigning at least one IF is based on a previously assigned IF; and
determining a plurality of mixing frequencies for converting the plurality of RF communications signals into a plurality of IF signals.

22. The computer readable medium of claim 21, wherein assigning the at least one IF based on the previously assigned IF comprises, for each IF:
determining a bandwidth requirement for the IF;
determining a center frequency and a bandwidth of the previously assigned IF;
determining the center frequency for the IF based on the bandwidth requirement for the IF, and on the center frequency and the bandwidth of the previously assigned IF; and
assigning the IF based on the center frequency of the IF and the bandwidth requirement for the IF.

23. The computer readable medium of claim 21, the method further comprising generating a management signal capable of enabling at least one device to convert the plurality of IF signals to the plurality of RF communications signals.
